(19) United States
(12) Patent Application Publication
(10) Pub. No.: US 2021/0256855 A1
(43) Pub. Date: Aug. 19, 2021

(54) INFORMATION TRANSMISSION METHODS AND APPARATUSES

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/252,236

(22) PCT Filed: Jun. 14, 2018
(86) PCT No.: PCT/CN2018/091359

§ 371 Date: Dec. 14, 2020

(51) Int. Cl. G08G 5/00; H04W 36/00; H04W 36/32; H04W 8/14; H04W 4/44

(52) U.S. Cl. CPC G08G 5/0013; G08G 5/003; G08G 5/0069; H04W 4/44; H04W 36/0058; H04W 36/32; H04W 8/14; H04W 36/0016

(57) ABSTRACT

The present disclosure provides an information transmission method and apparatus. The method is applicable to a source base station that currently provides network service to an UAV and the method includes: obtaining flight path information on the UAV; sending the flight path information to a target base station for the target base station to provide network service to the UAV according to the flight path information.

### TECHNICAL FIELD

The present disclosure relates to the field of communication, in particular to information transmission methods and apparatuses.

### BACKGROUND

The unmanned aerial vehicle is also known as UAV, which is operated by a radio remote control device with a program control apparatus therein.

With the continuous development of UAV technology, UAV has been widely used. In order to further expand the application range of UAV, cellular network is required to provide some expected service to UAV. However, there is not an existing technical solution for the cellular network obtaining the flight path information on UAV, which reduces the service quality provided by the cellular network for UAV.

### SUMMARY

In order to overcome the problems in the related art, the embodiments of the present disclosure provide an information transmission method and apparatus.

From a first aspect of the embodiments of the present disclosure, the method is applicable to a source base station that currently provides network service to an UAV, the method includes:

obtaining flight path information on an UAV;

sending the flight path information to a target base station for the target base station to provide network service to the UAV according to the flight path information.

Optionally, sending the flight path information to the target base station includes:

receiving a measurement report sent by the UAV;

in response to determining to prepare for a handover with the target base station according to the measurement report, sending the flight path information on the UAV to the target base station.

Optionally, the source base station is connected with the target base station through an X2 interface;

sending the flight path information to the target base station includes:

carrying the flight path information into a first handover request signaling; and

sending the first handover request signaling to the target base station.

Optionally, carrying the flight path information into a first handover request signaling includes:

adding a flight path information element for carrying the flight path information in the first handover request signaling; and

carrying the flight path information into the flight path information element.

Optionally, carrying the flight path information into a first handover request signaling includes:

adding a flight path information element for carrying the flight path information in a terminal assistance signaling, and carrying the flight path information into the flight path information element;

adding the terminal assistance signaling to a handover preparation signaling; and

carrying the handover preparation signaling into a first designated element in a first handover request signaling, and the first designated element is a radio resource control (RRC) context information element.

Optionally, the source base station is connected with a mobility management entity (MME) through a first S1 interface, and the MME is connected with the target base station through a second S1 interface;

sending the flight path information to the target base station includes:

carrying the flight path information into a handover required signaling;

sending the handover required signaling to the MME for the MME to send the flight path information in the handover required signaling to the target base station through a second handover request signaling.

Optionally, carrying the flight path information into the handover required signaling includes:

adding a flight path information element for carrying the flight path information in the handover required signaling;

carrying the flight path information into the flight path information element.

Optionally, carrying the flight path information into the handover required signaling includes:

adding a flight path information element for carrying the flight path information in a terminal assistance signaling, and carrying the flight path information into the flight path information element;

adding the terminal assistance signaling to a handover preparation signaling; and

carrying the handover preparation signaling into a second designated element in the handover required signaling, and the second designated element is a source to target base station transparent container information element.

From a second aspect of the embodiments of the present disclosure, an information transmission method is provided. The method is applicable to a target base station and includes:

receiving the flight path information on an UAV sent by a source base station;

providing network service to the UAV according to the flight path information.

Optionally, the source base station is connected with the target base station through an X2 interface;

receiving the flight path information on an UAV sent by a source base station includes:

receiving a first handover request signaling sent by the source base station, wherein the first handover request signaling includes the flight path information on the UAV;

obtaining the flight path information from the first handover request signaling.

Optionally, the first handover request signaling includes a flight path information element for carrying the flight path information;

obtaining the flight path information from the first handover request signaling includes:

obtaining the flight path information from the flight path information element included in the first handover request signaling.

Optionally, the first handover request signaling includes a first designated element, and the first designated element is an RRC context information element including a handover preparation signaling, the handover preparation signaling includes a terminal assistance signaling including a flight path information element for carrying the flight path information;

obtaining the flight path information from the first handover request signaling includes:

obtaining the flight path information from the flight path information element included in the terminal assistance signaling.

Optionally, the source base station is connected with a mobility management entity (MME) through a first S1 interface, and the MME is connected with the target base station through a second S1 interface;

receiving the flight path information on an UAV sent by a source base station includes:

receiving a second handover request signaling sent by the MME, the second handover request signaling includes the flight path information and is generated by the MME in response to receiving the handover required signaling which carries the flight path information sent by the source base station;

obtaining the flight path information from the second handover request signaling.

Optionally, the second handover request signaling includes a flight path information element for carrying the flight path information;

obtaining the flight path information from the second handover request signaling includes:

obtaining the flight path information from the flight path information element included in the second handover request signaling.

Optionally, the second handover request signaling includes a second designated element, the second designated element is a source to target base station transparent container information element; the second designated element includes a handover preparation signaling including a terminal assistance signaling, and the terminal assistance signaling includes a flight path information element for carrying the flight path information;

obtaining the flight path information from the second handover request signaling includes:

obtaining the flight path information from the flight path information element included in the terminal assistance signaling.

From a third aspect of the embodiments of the present disclosure, an information transmission apparatus is provided. The apparatus is applicable to an UAV and includes:

an obtaining module, configured to obtain flight path information on the UAV;

a sending module, configured to send the flight path information to a target base station for the target base station to provide network service to the UAV according to the flight path information.

Optionally, the sending module includes:

a receiving submodule, configured to receive a measurement report sent by the UAV;

a determining submodule, configured to, in response to determining to prepare for handover with the target base station according to the measurement report, send the flight path information on the UAV to the target base station.

Optionally, the source base station is connected with the target base station through an X2 interface; the sending module includes:

a first adding submodule, configured to carry the flight path information into a first handover request signaling;

a first sending submodule, configured to send the first handover request signaling to the target base station.

Optionally, the first adding submodule includes:

a second adding submodule, configured to add a flight path information element for carrying the flight path information in the first handover request signaling;

a third adding submodule, configured to carry the flight path information into the flight path information element.

Optionally, the first adding submodule includes:

a fourth adding submodule, configured to add a flight path information element for carrying the flight path information in a terminal assistance signaling, and carry the flight path information into the flight path information element;

a fifth adding submodule, configured to add the terminal assistance signaling to a handover preparation signaling;

a sixth adding submodule, configured to carry the handover preparation signaling into a first designated element in the first handover request signaling, and the first designated element is a RRC context information element.

Optionally, the source base station is connected with a MME through a first S1 interface, and the MME is connected with the target base station through a second S1 interface; and the sending module includes:

a seventh adding submodule, configured to carry the flight path information into a handover required signaling;

a second sending submodule, configured to send the handover required signaling to the MME for the MME to send the flight path information in the handover required signaling to the target base station through a second handover request signaling.

Optionally, the seventh adding submodule includes:

an eighth adding submodule, configured to add a flight path information element for carrying the flight path information in the handover required signaling;

a ninth adding submodule, configured to carry the flight path information into the flight path information element.

Optionally, the seventh adding submodule includes:

a tenth adding submodule, configured to add a flight path information element for carrying the flight path information in the terminal assistance signaling, and carry the flight path information into the flight path information element;

an eleventh adding submodule, configured to add the terminal assistance signaling to the handover preparation signaling;

a twelfth adding submodule, configured to carry the handover preparation signaling into a second designated element in the handover required signaling, wherein the second designated element is a source to target base station transparent container information element.

From a fourth aspect of the embodiments of the present disclosure, an information transmission apparatus is provided. The apparatus is applicable to a base station and includes:

a receiving module, configured to receive flight path information on an UAV sent by a source base station;

a processing module, configured to provide network service to the UAV according to the flight path information.

Optionally, the source base station is connected with the target base station through an X2 interface; the receiving module includes:

a first receiving submodule, configured to receive a first handover request signaling sent by the source base station, where the first handover request signaling includes the flight path information on the UAV;

a first obtaining submodule, configured to obtain the flight path information from the first handover request signaling.

Optionally, the first handover request signaling includes a flight path information element for carrying the flight path information; and the first obtaining submodule includes:

a second obtaining submodule, configured to obtain the flight path information from the flight path information element included in the first handover request signaling.

Optionally, the first handover request signaling includes a first designated element, and the first designated element is a radio resource control (RRC) context information element including a handover preparation signaling, the handover preparation signaling includes a terminal assistance signaling including a flight path information element for carrying the flight path information; and the first obtaining submodule includes:

a third obtaining submodule, configured to obtain the flight path information from the flight path information element included in the terminal assistance signaling.

Optionally, the source base station is connected with a MME through a first S1 interface, and the MME is connected with the target base station through a second S1 interface; and the receiving module includes:

a second receiving submodule, configured to receive a second handover request signaling sent by the MME, wherein the second handover request signaling includes the flight path information and is generated by the MME in response to receiving the handover required signaling which carries the flight path information sent by the source base station;

a fourth obtaining submodule, configured to obtain the flight path information from the second handover request signaling.

Optionally, the second handover request signaling includes a flight path information element for carrying the flight path information; and the second obtaining submodule includes:

a fifth obtaining submodule, configured to obtain the flight path information from the flight path information element included in the second handover request signaling.

Optionally, the second handover request signaling includes a second designated element, the second designated element is a source to target base station transparent container information element including a handover preparation signaling, the handover preparation signaling includes a terminal assistance signaling including a flight path information element for carrying the flight path information; and the second obtaining submodule includes:

a sixth obtaining submodule, configured to obtain the flight path information from the flight path information element included in the terminal assistance signaling.

From a fifth aspect of the embodiments of the present disclosure, a non-transitory computer-readable storage medium storing computer program thereon is provided. The computer program is used to execute the information transmission method of the first aspect.

From a sixth aspect of the embodiments of the present disclosure, a non-transitory computer-readable storage medium storing computer program thereon is provided. The computer program is used to execute the information transmission method of the second aspect.

From a seventh aspect of the embodiments of the present disclosure, an information transmission apparatus is provided. The apparatus is applicable to a source base station that currently provides network service to an UAV and the apparatus includes:

a processor;

a memory for storing instructions executable by the processor;

wherein, the processor is configured to:

obtain flight path information on an UAV;

send the flight path information to a target base station for the target base station to provide network service to the UAV according to the flight path information.

From an eighth aspect of the embodiments of the present disclosure, an information transmission apparatus is provided. The apparatus is applicable to a target base station and the apparatus includes:

a processor;

a memory for storing instructions executable by the processor;

wherein, the processor is configured to:

receive the flight path information on an UAV sent by a source base station;

provide network service to the UAV according to the flight path information.

The technical solutions provided by the examples of the present disclosure may include the following beneficial effects:

In the present disclosure, a source base station obtains flight path information on an UAV and sends the flight path information to a target base station, so that the target base station can provide network service to the UAV according to the flight path information on the UAV, thereby realizing the transmission of flight path information on UAV between base stations, and also improving the service quality of the target base station.

In the present disclosure, the target base station receives flight path information on an UAV sent by a source base station and provides network service to the UAV according to the flight path information, thereby realizing the transmission of flight path information on UAV between base stations, and also improving the service quality of the target base station.

It should be understood that the above general description and the following detailed description are only exemplary and explanatory, but not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating an information transmission method according to some embodiments;

FIG. 2A is an application scene diagram illustrating an information transmission method according to some embodiments;

FIG. 2B is another application scene diagram illustrating an information transmission method according to some embodiments;

FIG. 3 is a flowchart illustrating another information transmission method according to some embodiments;

FIG. 4 is a flowchart illustrating an information transmission method according to some embodiments;

FIG. 5 is a flowchart illustrating an information transmission method according to some embodiments;

FIG. 6 is a flowchart illustrating another information transmission method according to some embodiments;

FIG. 7 is a flowchart illustrating another information transmission method according to some embodiments;

FIG. 8 is a block diagram illustrating an information transmission apparatus according to some embodiments;

FIG. 9 is a block diagram illustrating another information transmission apparatus according to some embodiments;

FIG. 10 is a block diagram illustrating an information transmission apparatus according to some embodiments;

FIG. 11 is a block diagram illustrating another information transmission apparatus according to some embodiments;

FIG. 12 is a block diagram illustrating another information transmission apparatus according to some embodiments;

FIG. 13 is a block diagram illustrating another information transmission apparatus according to some embodiments;

FIG. 14 is a block diagram illustrating another information transmission apparatus according to some embodiments;

FIG. 15 is a block diagram illustrating another information transmission apparatus according to some embodiments;

FIG. 16 is a block diagram illustrating an information transmission apparatus according to some embodiments;

FIG. 17 is a block diagram illustrating another information transmission apparatus according to some embodiments;

FIG. 18 is a block diagram illustrating another information transmission apparatus according to some embodiments;

FIG. 19 is a block diagram illustrating another information transmission apparatus according to some embodiments;

FIG. 20 is a block diagram illustrating another information transmission apparatus according to some embodiments;

FIG. 21 is a block diagram illustrating another information transmission apparatus according to some embodiments;

FIG. 22 is a block diagram illustrating another information transmission apparatus according to some embodiments;

FIG. 23 is a structural schematic diagram illustrating an information transmission apparatus according to some embodiments;

FIG. 24 is a structural schematic diagram illustrating an information transmission apparatus according to some embodiments.

### DETAILED DESCRIPTION OF THE EMBODIMENTS

Examples will be described in detail here with the examples thereof expressed in the drawings. Where the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The term used in the present disclosure is for the purpose of describing particular examples only and is not intended to limit the present disclosure. As used in this disclosure and the appended claims, the singular forms “a”, “an” and “the” are intended to include the plural forms as well, unless the context clearly indicates otherwise. It should also be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish one category of information from another. For example, without departing from the scope of the present disclosure, indication information may be referred as second information; and similarly, second information may also be referred as indication information. As used herein, the term “if” may be interpreted as “when” or “upon” or “in response to determining” depending on the context.

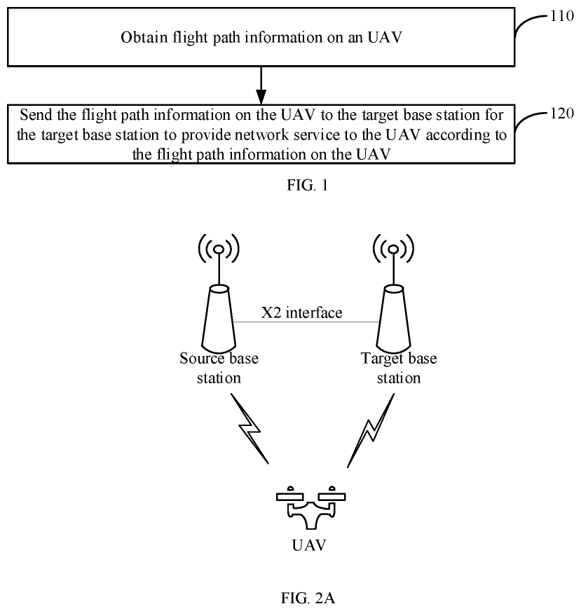

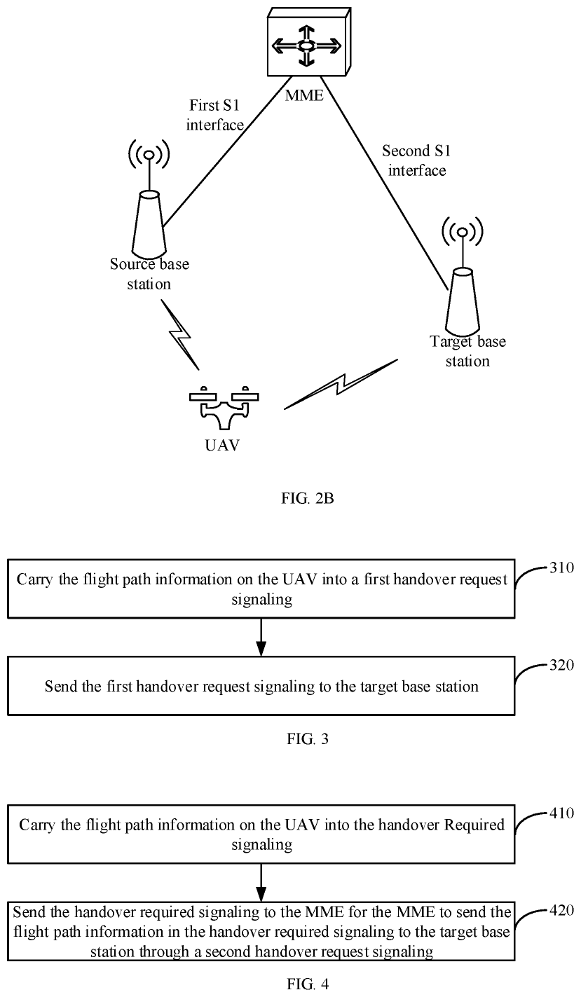

FIG. 1 is a flowchart illustrating an information transmission method according to some embodiments. FIG. 2A and FIG. 2B are both application scene diagrams illustrating information transmission methods according to some embodiments. The information transmission method is applicable to a source base station that currently provides network service to an UAV. As shown in FIG. 1, the information transmission method may include steps 110-120.

At step 110, flight path information on an UAV is obtained.

In the embodiments of the present disclosure, after the source base station obtains the flight path information on the UAV, in addition to predicting which base station the UAV may pass through, the source base station can also notify a target base station of the flight path information during cell handover, so that the target base station can also predict which base station the UAV may pass through, thereby providing better network service to the UAV.

In addition, there are many ways for the source base station to obtain the flight path information on the UAV. It can be that the UAV actively reports the flight path information to the source base station or the source base station obtains the flight path information on the UAV from a core network device.

At step 120, the flight path information on the UAV is sent to the target base station for the target base station to provide network service to the UAV according to the flight path information on the UAV.

In the embodiments of the present disclosure, after the target base station obtains the flight path information on the UAV, the target base station can also predict which base station the UAV may pass through according to the flight path information on the UAV.

In an embodiment, during the cell handover, performing step 120 may include:

(1-1) receiving a measurement report sent by the UAV;

(1-2) in response to determining to prepare for handover with the target base station according to the measurement report, sending the flight path information on the UAV to the target base station.

In an example application scenario, as shown in FIG. 2A, the application scenario includes a UAV, a source base station, and a target base station. The source base station is connected with the target base station through X2 interface. After the source base station obtains the flight path information on the UAV, the base station may send the flight path information to the target base station through the X2 interface, so that the target base station can provide network service to the UAV based on the flight path information on the UAV. The X2 interface is an interconnection interface between base stations and supports direct transmission of data and signaling.

In an example application scenario, as shown in FIG. 2B, the application scenario includes an UAV, a source base station, a mobility management entity (MME), and a target base station. The source base station is connected with the MME through a first S1 interface, and the MME is connected with the target base station through a second S1 interface. After the source base station obtains the flight path information on the UAV, the source base station can send the flight path information to the MME through the first S1 interface for the MME to send the flight path information to the target base station through the second S1 interface, so that the target base station can provide network service to the UAV based on the flight path information on the UAV. The S1 interface is the communication interface between the base station and the MME.

It can be seen from the above embodiment that by collecting the flight path information on the UAV, and sending the flight path information on the UAV to the target base station, the target base station can provide network service to the UAV based on the flight path information on the UAV, which realizes the function of transmitting the flight path information on the UAV between base stations, and also improves the service quality of the target base station.

FIG. 3 is a flowchart illustrating another information transmission method according to some embodiments. The information transmission method may be applied in a source base station that currently provides network service to an UAV, and the method is based on the method shown in FIG. 1, the source base station is connected with the target base station through the X2 interface; as shown in FIG. 3, upon performing step 120, the following steps 310-320 may be included.

At step 310, the flight path information on the UAV is carried into a first handover request signaling.

In the embodiments of the present disclosure, the source base station may notify the target base station of the flight path information on the UAV through the first handover request signaling. For example, the source base station carries the flight path information on the UAV into a designated location or designated element of the first handover request signaling, so that the target base station can obtain the flight path information from the first handover request signaling.

In an embodiment, upon performing step 310, the following implementations can be adopted but not limited to:

Method 1: Modify an X2AP (X2 access point) signaling directly. In this way, the method includes:

(2-1) Adding a flight path information element for carrying the flight path information in the first handover request signaling. The flight path information element is a newly added information element.

(2-2) Carrying the flight path information into the flight path information element.

Method 2: Modify a radio resource control (RRC) signaling. In this way, the method includes:

(3-1) Adding a flight path information element for carrying the flight path information in the terminal assistance signaling, and carrying the flight path information into the flight path information element;

(3-2) Adding the terminal assistance signaling to the handover preparation signaling;

(3-3) Carrying the handover preparation signaling into a first designated element in a first handover request signaling, where the first designated element is an RRC context information element.

At step 320, the first handover request signaling is sent to the target base station.

It can be seen from the above embodiments that the flight path information on the UAV is carried into the first handover request signaling, and the first handover request signaling is sent to the target base station, thereby meeting the information transmission requirements based on the X2 interface, and improving the accuracy and efficiency of information transmission.

FIG. 4 is a flowchart illustrating another information transmission method according to some embodiments. The information transmission method may be applied in a source base station that currently provides network service to an UAV, and the method is based on the method shown in FIG. 1, the source base station is connected with the MME through the first S1 interface, and the MME is connected with the target base station through the second S1 interface; as shown in FIG. 4, upon performing step 120 is performed, the following steps 410-420 may be included.

At step 410, the flight path information on the UAV is carried into a handover required signaling.

In the embodiments of the present disclosure, the source base station may notify the MME of the flight path information on the UAV through the handover required signaling, and then the MME notifies the target base station of the flight path information on the UAV through the second handover request signaling. For example, the source base station carries the flight path information on the UAV into a designated location or a designated element in the handover required signaling, so that the MME can obtain the flight path information from the handover required signaling, and then carries the flight path information into a second handover request signaling, and send the second handover request signaling to the target base station. In this way the target base station may learn the flight path information on the UAV sent by the source base station through the MME.

In an embodiment, upon performing step 410, the following implementation can be adopted but not limited to:

(4-1) Adding a flight path information element for carrying the flight path information in the handover required signaling. The flight path information element is a newly added information element.

(4-2) Carrying the flight path information into the flight path information element.

In an embodiment, upon performing step 410, the following implementation can be adopted but not limited to:

(5-1) Adding a flight path information element for carrying the flight path information in a terminal assistance signaling, and carrying the flight path information into the flight path information element;

(5-2) Adding the terminal assistance signaling to a handover preparation signaling;

(5-3) Carrying the handover preparation signaling into a second designated element in the handover required signaling, where the second designated element is a source to target base station transparent container information element.

At step 420, the handover required signaling is sent to the MME for the MME to send the flight path information in the handover required signaling to the target base station through a second handover request signaling.

It can be seen from the above embodiment that the flight path information on the UAV is carried into the handover required signaling, and the handover required signaling is sent to the MME for the MME to send the flight path information in the handover required signaling to the target base station through the second handover request signaling, thereby meeting the information transmission requirements based on the S1 interface, and also improving the accuracy and efficiency of information transmission.

FIG. 5 is a flowchart illustrating an information transmission method according to some embodiments. The information transmission method may be applied in a target base station. As shown in FIG. 5, the information transmission method may include the following steps 510-520.

At step 510, the flight path information on the UAV sent by the source base station is received.

In the embodiments of the present disclosure, after the target base station receives the flight path information on the UAV sent by the source base station, the target base station can predict which base station the UAV may pass through, so as to provide better network service to the UAV.

At step 520, the network service is provided to the UAV according to the flight path information on the UAV.

It can be seen from the above embodiment that the flight path information on the UAV sent by the source base station is received, and the network service is provided to the UAV according to the flight path information on the UAV, thereby realizing transmission of the flight path information on the UAV between the base stations and improving the service quality of the target base station.

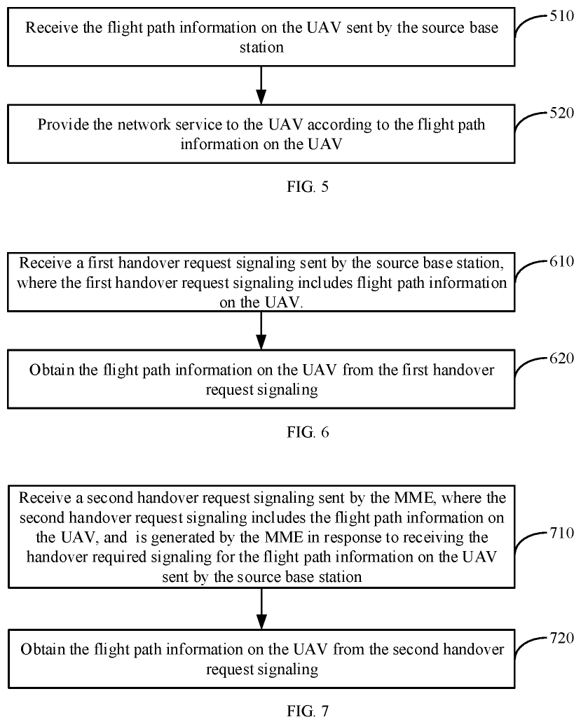

FIG. 6 is a flowchart illustrating another information transmission method according to some embodiments. The information transmission method may be applied in a target base station and the method is based on the method shown in FIG. 5. The source station is connected with the target base station through an X2 interface (refer to the application scenario shown in FIG. 2A); as shown in FIG. 6, upon performing step 510, the following steps 610-620 may be included.

At step 610, a first handover request signaling sent by the source base station is received, where the first handover request signaling includes flight path information on the UAV.

At step 620, the flight path information on the UAV is obtained from the first handover request signaling.

In the embodiments of the present disclosure, since the source base station may use different methods to carry the flight path information on the UAV into the first handover request signaling, when the target base station obtains the flight path information on the UAV, the target base station also needs to obtain the flight path information on the UAV using an obtaining method corresponding to the adding method.

In an embodiment, the first handover request signaling includes a flight path information element for carrying flight path information on the UAV; upon performing step 620, the flight path information is obtained from the flight path information element included in the first handover request signaling.

In an embodiment, the first handover request signaling includes a first designated element, and the first designated element is an RRC context information element; the RRC context information element includes a handover preparation signaling, the handover preparation signaling includes a terminal assistance signaling, and the terminal assistance signaling includes a flight path information element for carrying the flight path information; upon performing step 620, the flight path information may be obtained from the flight path information element included in the terminal assistance signaling.

It can be seen from the above embodiment that the first handover request signaling sent by the source base station is received, where the first handover request signaling includes flight path information on the UAV, and the flight path information on the UAV is obtained from the first handover request signaling, thereby realizing information transmission based on the X2 interface and improving the accuracy and efficiency of information transmission.

FIG. 7 is a flowchart illustrating another information transmission method according to some embodiments. The information transmission method may be applied in a target base station. The method is based on the method shown in FIG. 5. The source base station is connected with the MME through a first S1 interface and the MME is connected with the target base station through a second S1 interface (refer to the application scenario shown in FIG. 2B); as shown in FIG. 7, upon performing step 510, the following steps 710-720 may be included:

At step 710, a second handover request signaling sent by the MME is received, where the second handover request signaling includes the flight path information on the UAV, and the second handover request signaling is generated after the MME receives the handover required signaling for the flight path information on the UAV sent by the source base station.

At step 720, the flight path information on the UAV is obtained from the second handover request signaling.

In the embodiments of the present disclosure, since the MME may use different methods to carry the flight path information on the UAV into the second handover request signaling, when the target base station obtains the flight path information on the UAV, the target base station also needs to obtain the flight path information on the UAV using an obtaining method corresponding to the adding method.

For example, after the MME receives the handover required signaling sent by the source base station, and the handover required signaling includes the flight path information element for carrying the flight path information on the UAV, the MME may obtain the flight path information from the flight path information element included in the handover required signaling, add the flight path information element for carrying the flight path information to the second handover request signaling, and carry the flight path information the flight path information element included in the second handover request signaling correspondingly:

In an embodiment, the second handover request signaling includes a flight path information element for carrying the flight path information; upon performing step 720, the flight path information may be obtained from the flight path information element included in the second handover request signaling.

For another example, the MME receives the handover required signaling sent by the source base station, and the handover required signaling includes a second designated element, and the second designated element is a source to target base station transparent container information element. The second designated element includes a handover preparation signaling, the handover preparation signaling includes a terminal assistance signaling. The MME may directly add the handover preparation signaling including the flight path information to the source to target base station transparent container information element included in the second handover request signaling. Correspondingly:

In an embodiment, the second handover request signaling includes a second designated element, and the second designated element is a source to target base station transparent container information element. The second designated element includes a handover preparation signaling, the handover preparation signaling includes a terminal assistance signaling. The terminal assistance signaling includes a flight path information element for carrying the flight path information. Upon performing step 720, the flight path information may be obtained from the flight path information element included in the terminal assistance signaling.

It can be seen from the above embodiments that a second handover request signaling sent by the MME is received, where the second handover request signaling includes the flight path information on the UAV, and the flight path information on the UAV is obtained from the second handover request signaling, hereby realizing information transmission based on the S1 interface and improving the accuracy and efficiency of information transmission.

Corresponding to the embodiments of information transmission methods, the present disclosure also provides embodiments of information transmission apparatuses.

FIG. 8 is a block diagram illustrating an information transmission apparatus according to some embodiments. The information transmission apparatus may be applied in a source base station that currently provides network service to an UAV and used for executing the information transmission method shown in FIG. 1. As shown in FIG. 0.8, the information transmission apparatus may include:

an obtaining module 81, configured to obtain flight path information on an UAV;

a sending module 82, configured to send the flight path information to a target base station for the target base station to provide network service to the UAV according to the flight path information.

It can be seen from the above embodiment that by collecting the flight path information on the UAV, and sending the flight path information on the UAV to the target base station, the target base station can provide network service to the UAV based on the flight path information on the UAV, which realizes the function of transmitting the flight path information on the UAV between base stations, and also improves the service quality of the target base station.

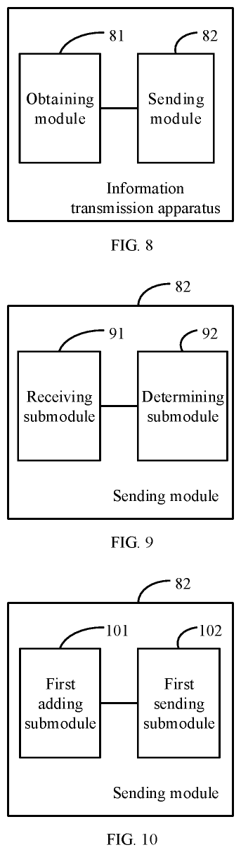

In an embodiment, based on the apparatus shown in FIG. 8, as shown in FIG. 9, the sending module 82 may include:

a receiving submodule 91, configured to receive a measurement report sent by the UAV;

a determining submodule 92, configured to, in response to determining to prepare for handover with the target base station according to the measurement report, send the flight path information on the UAV to the target base station.

In one embodiment, based on the apparatus shown in FIG. 8, as shown in FIG. 10, the sending module 82 may include:

a first adding submodule 101, configured to carry the flight path information into a first handover request signaling;

a first sending submodule 102, configured to send the first handover request signaling to the target base station.

It can be seen from the above embodiment that the flight path information on the UAV is carried into the first handover request signaling, and the first handover request signaling is sent to the target base station, thereby meeting the information transmission requirements based on the X2 interface, and improving the accuracy and efficiency of information transmission.

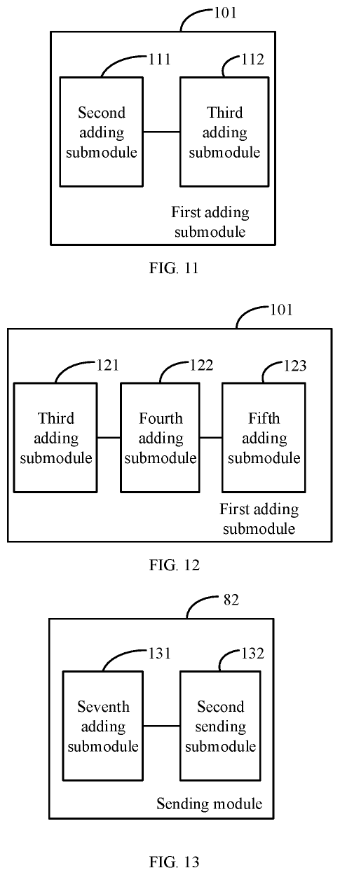

In an embodiment, based on the apparatus shown in FIG. 10, as shown in FIG. 11, the first adding submodule 101 may include:

a second adding submodule 111, configured to add a flight path information element for carrying the flight path information in the first handover request signaling;

a third adding submodule 112, configured to carry the flight path information into the flight path information element.

In an embodiment, based on the apparatus shown in FIG. 10, as shown in FIG. 12, the first adding submodule 101 may include:

a fourth adding submodule 121, configured to add a flight path information element for carrying the flight path information in a terminal assistance signaling, and carry the flight path information into the flight path information element;

a fifth adding submodule 122, configured to add the terminal assistance signaling to a handover preparation signaling;

a sixth adding submodule 123, configured to carry the handover preparation signaling into a first designated element in the first handover request signaling, and the first designated element is a RRC context information element.

In an embodiment, based on the apparatus shown in FIG. 8, as shown in FIG. 13, the sending module 82 may include:

a seventh adding submodule 131, configured to carry the flight path information into a handover required signaling;

a second sending submodule 132, configured to send the handover required signaling to the MME for the MME to send the flight path information in the handover required signaling to the target base station through the second handover request signaling.

It can be seen from the above embodiment that the flight path information on the UAV is carried into the handover required signaling, and the handover required signaling is sent to the MME for the MME to send the flight path information in the handover required signaling to the target base station through the second handover request signaling, thereby meeting the information transmission requirements based on the S1 interface, and also improving the accuracy and efficiency of information transmission.

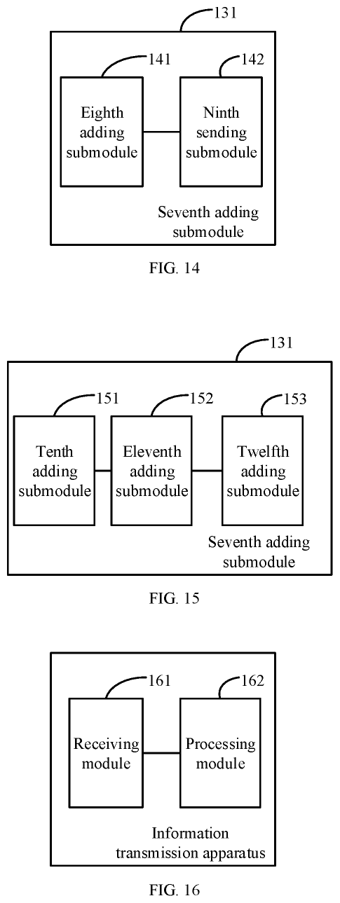

In an embodiment, based on the apparatus shown in FIG. 13, as shown in FIG. 14, the seventh adding submodule 131 may include:

an eighth adding submodule 141, configured to add a flight path information element for carrying the flight path information in the handover required signaling;

a ninth adding submodule 142, configured to carry the flight path information into the flight path information element.

In an embodiment, based on the apparatus shown in FIG. 13, as shown in FIG. 15, the seventh adding submodule 131 may include:

a tenth adding submodule 151, configured to add a flight path information element for carrying the flight path information in the terminal assistance signaling, and carry the flight path information into the flight path information element;

an eleventh adding submodule 152, configured to add the terminal assistance signaling to the handover preparation signaling;

a twelfth adding submodule 153, configured to carry the handover preparation signaling into a second designated element in the handover required signaling, and the second designated element is a source to target base station transparent container information element.

FIG. 16 is a block diagram illustrating an information transmission apparatus according to some embodiments. The information transmission apparatus may be applied in a target base station and used for executing the information transmission method shown in FIG. 5. As shown in FIG. 16, the information transmission apparatus may include:

a receiving module 161, configured to receive flight path information on an UAV sent by a source base station;

a processing module 162, configured to provide network service to the UAV according to the flight path information.

It can be seen from the above embodiment that the flight path information on the UAV sent by the source base station is received, and the network service is provided to the UAV according to the flight path information on the UAV, thereby realizing transmission of the flight path information on the UAV between the base stations and improving the service quality of the target base station.

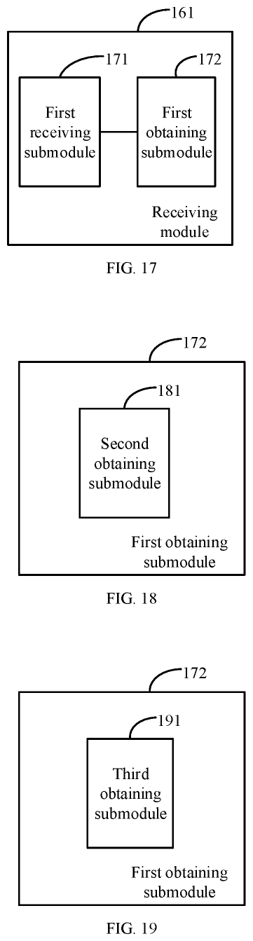

In an embodiment, based on the apparatus shown in FIG. 16, as shown in FIG. 17, the receiving module 161 may include:

a first receiving submodule 171, configured to receive a first handover request signaling sent by the source base station, where the first handover request signaling includes the flight path information on the UAV;

a first obtaining submodule 172, configured to obtain the flight path information from the first handover request signaling.

It can be seen from the above embodiment that the first handover request signaling sent by the source base station is received, where the first handover request signaling includes flight path information on the UAV, and the flight path information on the UAV is obtained from the first handover request signaling, thereby realizing information transmission based on the X2 interface and improving the accuracy and efficiency of information transmission.

In an embodiment, based on the apparatus shown in FIG. 17, as shown in FIG. 18, the first handover request signaling includes a flight path information element for carrying the flight path information, the first obtaining submodule 172 may include:

a second obtaining submodule 181, configured to obtain the flight path information from the flight path information element included in the first handover request signaling.

In an embodiment, based on the apparatus shown in FIG. 17, as shown in FIG. 19, the first handover request signaling includes a first designated element, and the first designated element is an RRC context information element; the RRC context information element includes a handover preparation signaling, the handover preparation signaling includes a terminal assistance signaling, and the terminal assistance signaling includes a flight path information element for carrying the flight path information; the first obtaining submodule 172 may include:

a third obtaining submodule 191, configured to obtain the flight path information from the flight path information element included in the terminal assistance signaling.

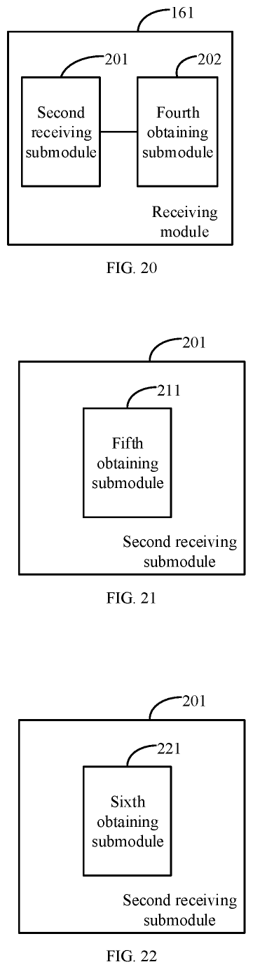

In an embodiment, based on the apparatus shown in FIG. 16, as shown in FIG. 20, the receiving module 161 may include:

a second receiving submodule 201, configured to receive a second handover request signaling sent by the MME, the second handover request signaling includes the flight path information, and the second handover request signaling is generated by the MME in response to receiving the handover required signaling which carries the flight path information sent by the source base station;

a fourth obtaining submodule 202, configured to obtain the flight path information from the second handover request signaling.

It can be seen from the above embodiments that a second handover request signaling sent by the MME is received, where the second handover request signaling includes the flight path information on the UAV, and the flight path information on the UAV is obtained from the second handover request signaling, hereby realizing information transmission based on the S1 interface and improving the accuracy and efficiency of information transmission.

In an embodiment, based on the apparatus shown in FIG. 20, as shown in FIG. 21, the second handover request signaling includes a flight path information element for carrying the flight path information; the second receiving submodule 201 may include:

a fifth obtaining submodule 211, configured to obtain the flight path information from the flight path information element included in the second handover request signaling.

In an embodiment, based on the apparatus shown in FIG. 20, as shown in FIG. 22, the second handover request signaling includes a second designated element, the second designated element is a source to target base station transparent container information element; the second designated element includes a handover preparation signaling, the handover preparation signaling includes a terminal assistance signaling, and the terminal assistance signaling includes a flight path information element for carrying the flight path information; the second receiving submodule 201 may include:

a sixth obtaining submodule 221, configured to obtain the flight path information from the flight path information element included in the terminal assistance signaling.

Since the device examples substantially correspond to the method examples, a reference may be made to part of the descriptions of the method examples for the related part. The device examples described above are merely illustrative, where above units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the examples. Those of ordinary skill in the art may understand and carry out them without creative work.

Correspondingly, the present disclosure also provides a non-transitory computer-readable storage medium storing a computer program thereon, wherein the computer program is used to execute the information transmission method described in any one of FIGS. 1 to 4.

Correspondingly, the present disclosure also provides a non-transitory computer-readable storage medium storing a computer program thereon, wherein the computer program is used to execute the information transmission method described in any one of FIGS. 5 to 7.

Correspondingly, the present disclosure also provides an information transmission apparatus, which is applied in a source base station that currently provides network service to an UAV, and the apparatus includes:

a processor;

a memory for storing instructions executable by the processor;

wherein, the processor is configured to:

obtain flight path information on an UAV;

send the flight path information to a target base station for the target base station to provide network service to the UAV according to the flight path information.

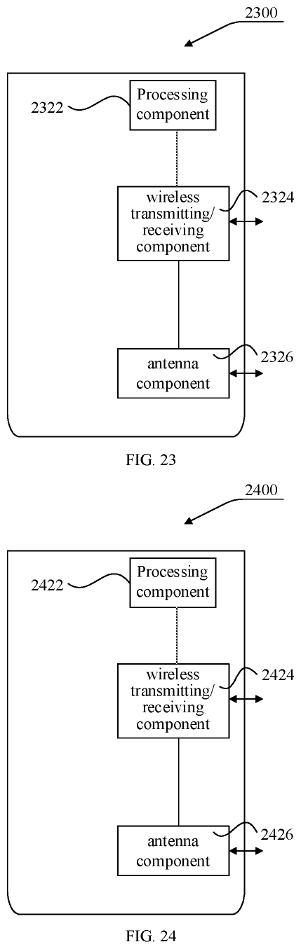

As shown in FIG. 23, FIG. 23 is a structural schematic diagram illustrating an information transmission apparatus according to some embodiments. An apparatus 2300 may be provided as a source base station. Referring to FIG. 23, the apparatus 2300 includes a processing component 2322, a wireless transmitting/receiving component 2324, an antenna component 2326, and a signal processing portion specific to a wireless interface. The processing component 2322 may further include one or more processors.

One the processor of the processing component 2322 may be configured to execute any of the foregoing information transmission methods.

Correspondingly, the present disclosure also provides an information transmission apparatus, which is applied in a target base station, and the apparatus includes:

a processor;

a memory for storing instructions executable by the processor;

wherein, the processor is configured to:

receive the flight path information on an UAV sent by a source base station;

provide network service to the UAV according to the flight path information.

As shown in FIG. 24, FIG. 24 is a structural schematic diagram illustrating an information transmission apparatus according to some embodiments. An apparatus 2400 may be provided as a source base station. Referring to FIG. 24, the apparatus 2400 includes a processing component 2422, a wireless transmitting/receiving component 2424, an antenna component 2426, and a signal processing portion specific to a wireless interface. The processing component 2422 may further include one or more processors.

One the processor of the processing component 2422 may be configured to execute any of the foregoing information transmission methods.

It is to be understood that this disclosure is not limited to the above described structures shown in the drawings, and various changes and modifications can be made to the disclosure without departing from the scope thereof. The scope of the disclosure is to be limited only by the appended claims.

What is claimed is:

1. An information transmission method, comprising:
obtaining, by a source base station that currently provides network service to an unmanned aerial vehicle (UAV), flight path information on the UAV; and
sending, by the source base station, the flight path information to a target base station for the target base station to provide network service to the UAV according to the flight path information.

2. The method of claim 1, wherein sending the flight path information to the target base station comprises:
receiving a measurement report sent by the UAV;
in response to determining to prepare for a handover with the target base station according to the measurement report, sending the flight path information on the UAV to the target base station.

3. The method of claim 1, wherein the source base station is connected with the target base station through an X2 interface, and sending the flight path information to the target base station comprises:
carrying the flight path information into a first handover request signaling; and
sending the first handover request signaling to the target base station.

4. The method of claim 3, wherein carrying the flight path information into a first handover request signaling comprises:
adding a flight path information element for carrying the flight path information in the first handover request signaling; and
carrying the flight path information into the flight path information element.

5. The method of claim 3, wherein carrying the flight path information into a first handover request signaling comprises:
adding a flight path information element for carrying the flight path information in a terminal assistance signaling;
carrying the flight path information into the flight path information element;
adding the terminal assistance signaling to a handover preparation signaling; and
carrying the handover preparation signaling into a first designated element in a first handover request signaling, wherein the first designated element is a radio resource control (RRC) context information element.

6. The method of claim 1, wherein the source base station is connected with a mobility management entity (MME) through a first S1 interface, the MME is connected with the target base station through a second S1 interface, and sending the flight path information to the target base station comprises:
carrying the flight path information into a handover required signaling;
sending the handover required signaling to the MME for the MME to send the flight path information in the handover required signaling to the target base station through a second handover request signaling.

7. The method of claim 6, wherein carrying the flight path information into a handover required signaling comprises:
adding a flight path information element for carrying the flight path information in the handover required signaling;
carrying the flight path information into the flight path information element.

8. The method of claim 6, wherein carrying the flight path information into a handover required signaling comprises:
adding a flight path information element for carrying the flight path information in a terminal assistance signaling;
carrying the flight path information into the flight path information element;
adding the terminal assistance signaling to a handover preparation signaling; and
carrying the handover preparation signaling into a second designated element in the handover required signaling, wherein the second designated element is a source to target base station transparent container information element.

9. An information transmission method, comprising:
receiving, by a target base station, flight path information on an UAV sent by a source base station; and
providing, by the target base station, network service to the UAV according to the flight path information.

10. The method of claim 9, wherein the source base station is connected with the target base station through an X2 interface, and receiving flight path information on an UAV sent by a source base station comprises:
receiving a first handover request signaling sent by the source base station, wherein the first handover request signaling comprises the flight path information on the UAV;
obtaining the flight path information from the first handover request signaling.

11. The method of claim 10, wherein the first handover request signaling comprises a flight path information element for carrying the flight path information, and obtaining the flight path information from the first handover request signaling comprises:
obtaining the flight path information from the flight path information element comprised in the first handover request signaling.

12. The method of claim 10, wherein the first handover request signaling comprises a first designated element, the first designated element is a radio resource control (RRC) context information element comprising a handover preparation signaling, the handover preparation signaling comprises a terminal assistance signaling comprising a flight path information element for carrying the flight path information, and obtaining the flight path information from the first handover request signaling comprises:
obtaining the flight path information from the flight path information element comprised in the terminal assistance signaling.

13. The method of claim 9, wherein the source base station is connected with a mobility management entity (MME) through a first S1 interface, the MME is connected with the target base station through a second S1 interface, and receiving the flight path information on an UAV sent by a source base station comprises:
receiving a second handover request signaling sent by the MME, wherein the second handover request signaling comprises the flight path information and is generated by the MME in response to receiving the handover required signaling which carries the flight path information sent by the source base station;
obtaining the flight path information from the second handover request signaling.

14. The method of claim 13, wherein the second handover request signaling comprises a flight path information element for carrying the flight path information, and obtaining the flight path information from the second handover request signaling comprises:
obtaining the flight path information from the flight path information element comprised in the second handover request signaling.

15. The method of claim 13, wherein the second handover request signaling comprises a second designated element, the second designated element is a source to target base station transparent container information element comprising a handover preparation signaling, the handover preparation signaling comprises a terminal assistance signaling comprising a flight path information element for carrying the flight path information, and obtaining the flight path information from the second handover request signaling comprises:
obtaining the flight path information from the flight path information element comprised in the terminal assistance signaling.

16-30. (canceled)

31. A non-transitory computer-readable storage medium storing computer program thereon, wherein the computer readable medium is used to execute the information transmission method of claim 1.

32. A non-transitory computer-readable storage medium storing computer program thereon, wherein the computer readable medium is used to execute the information transmission method of claim 9.

33. An information transmission apparatus, being applicable to a source base station that currently provides network service to an UAV, comprising:
a processor;
a memory for storing instructions executable by the processor;
wherein, the processor is configured to:
obtain flight path information on an UAV; and
send the flight path information to a target base station for the target base station to provide network service to the UAV according to the flight path information.

34. An information transmission apparatus, being applicable to a target base station, comprising:
a processor;
a memory for storing instructions executable by the processor;
wherein, the processor is configured to execute the information transmission method of claim 9.
